(19) United States
(12) Patent Application Publication
(10) Pub. No.: US 2018/0338888 A1
(43) Pub. Date: Nov. 29, 2018

(54) Eye Washing Assembly

(71) Applicant: Sterling Stennis, St. Paul, MN (US)

(72) Inventor: Sterling Stennis, St. Paul, MN (US)

(21) Appl. No.: 15/602,242

(22) Filed: May 23, 2017

(51) Int. Cl. A61H 35/02

(52) U.S. Cl. CPC A61H 35/02

(57) ABSTRACT

An eye washing assembly for washing an eye includes a handle that is selectively manipulated. A cup is coupled to the handle and the cup is selectively aligned with an eye. A washing unit is coupled to the handle and the washing unit contains a liquid. The washing unit is selectively turned on to urge the liquid outwardly through the cup thereby facilitating the eye to be washed.

### CROSS-REFERENCE TO RELATED APPLICATIONS

Not Applicable

### STATEMENT REGARDING FEDERALLY SPONSORED RESEARCH OR DEVELOPMENT

Not Applicable

### THE NAMES OF THE PARTIES TO A JOINT RESEARCH AGREEMENT

Not Applicable

### INCORPORATION-BY-REFERENCE OF MATERIAL SUBMITTED ON A COMPACT DISC OR AS A TEXT FILE VIA THE OFFICE ELECTRONIC FILING SYSTEM

Not Applicable

### STATEMENT REGARDING PRIOR DISCLOSURES BY THE INVENTOR OR JOINT INVENTOR

Not Applicable

### BACKGROUND OF THE INVENTION

### (1) Field of the Invention

### (2) Description of Related Art Including Information Disclosed Under 37 CFR 1.97 and 1.98

The disclosure and prior art relates to washing devices and more particularly pertains to a new washing device for washing an eye.

### BRIEF SUMMARY OF THE INVENTION

An embodiment of the disclosure meets the needs presented above by generally comprising a handle that is selectively manipulated. A cup is coupled to the handle and the cup is selectively aligned with an eye. A washing unit is coupled to the handle and the washing unit contains a liquid. The washing unit is selectively turned on to urge the liquid outwardly through the cup thereby facilitating the eye to be washed.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF SEVERAL VIEWS OF THE DRAWING(S)

The disclosure will be better understood and objects other than those set forth above will become apparent when consideration is given to the following detailed description thereof. Such description makes reference to the annexed drawings wherein:

FIG. 1 is a top perspective view of an eye washing assembly according to an embodiment of the disclosure.

FIG. 2 is a bottom view of an embodiment of the disclosure.

FIG. 3 is left side view of an embodiment of the disclosure.

FIG. 4 is a top view of an embodiment of the disclosure.

FIG. 5 is a cross sectional view taken along line 5-5 of FIG. 2 of an embodiment of the disclosure.

FIG. 6 is a perspective view of an alternative embodiment of the disclosure.

### DETAILED DESCRIPTION OF THE INVENTION

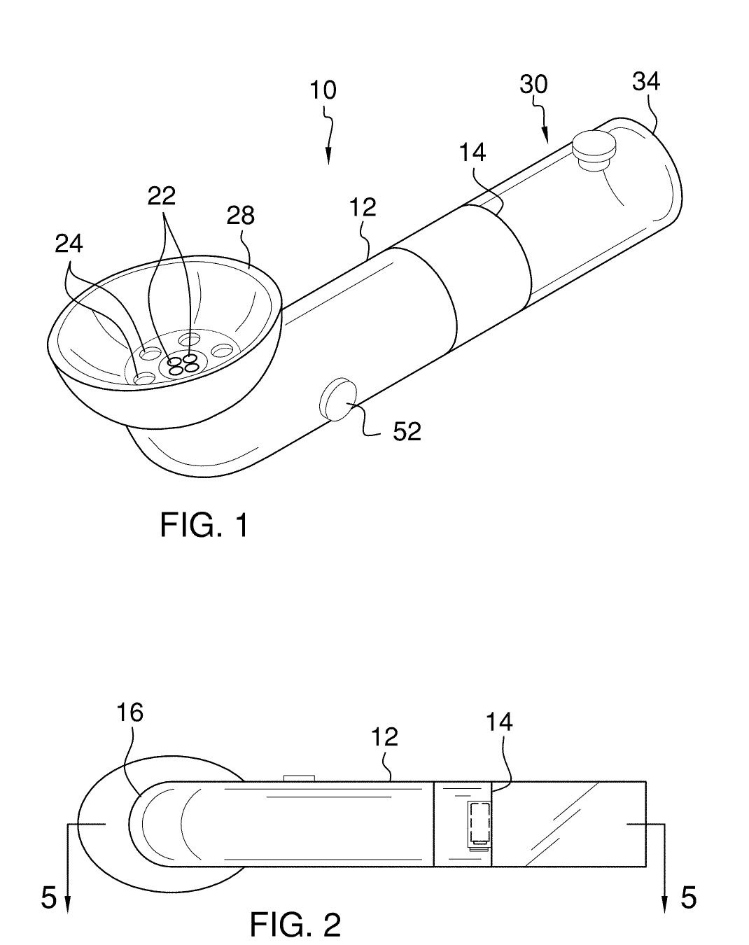

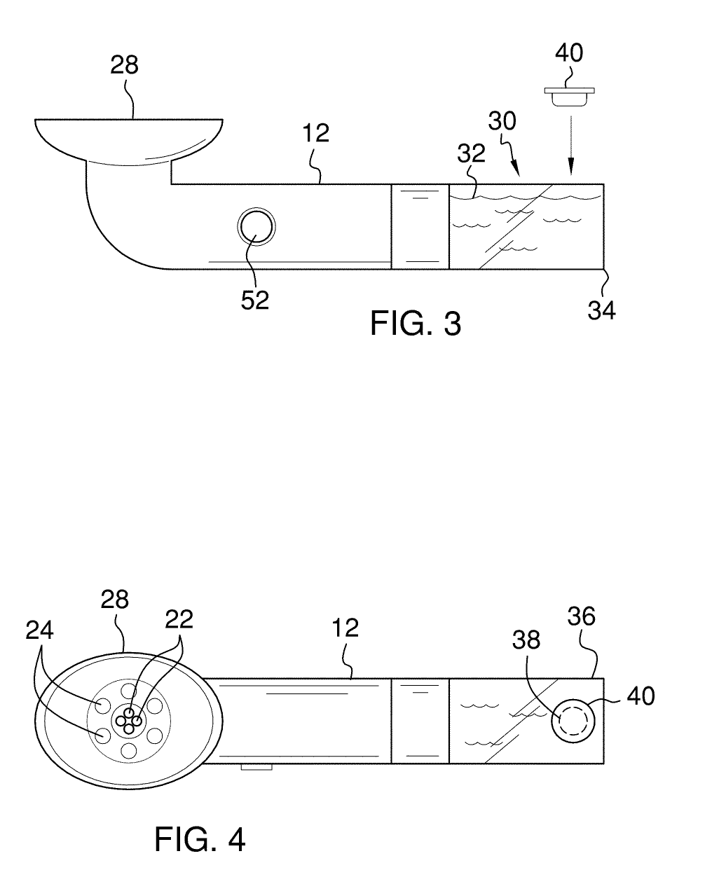

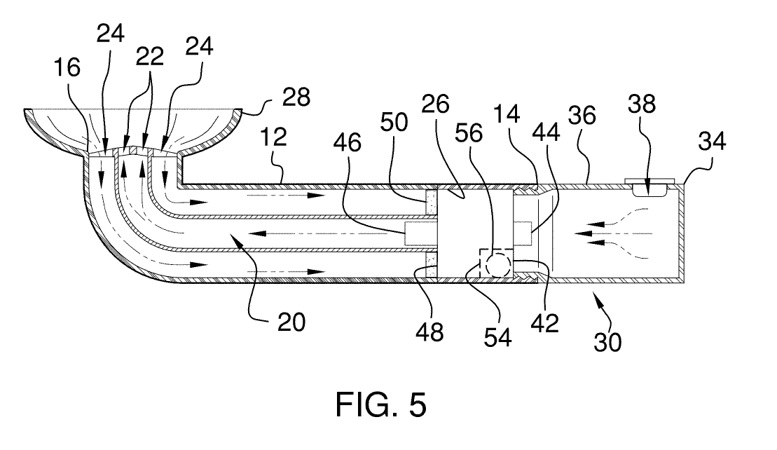

With reference now to the drawings, and in particular to FIGS. 1 through 6 thereof, a new washing device embodying the principles and concepts of an embodiment of the disclosure and generally designated by the reference numeral 10 will be described.

As best illustrated in FIGS. 1 through 6, the eye washing assembly 10 generally comprises a handle 12 that is selectively manipulated. The handle 12 has a first end 14 and a second end 16; the first end 14 is open and the handle 12 is substantially hollow. The handle 12 has a bend 18 thereon such that the second end 16 is directed upwardly from the handle 12. The handle 12 has a conduit 20 therein and the conduit 20 extends from the second end 16 toward the first end 14.

The second end 16 has a plurality of first apertures 22 extending into the conduit 20 and the second end 16 has a plurality of second apertures 24 extending into an interior of the handle 12. The second apertures 24 are spaced apart from each other and are distributed around the first apertures 22. The handle 12 an inside surface 26 and the inside surface 26 is threaded adjacent to the first end 14.

A cup 28 is coupled to the handle 12 and the cup 28 is aligned with an eye. The cup 28 is coupled to and extends away from the second end 16 and each of the first 22 and second 24 apertures is exposed in the cup 28. The cup 28 may be elongated such that the cup 28 has an ovoid shape thereby facilitating said cup 28 to conform to the shape of a human eye.

A washing unit 30 is coupled to the handle 12 and the washing unit 30 contains a liquid 32. The liquid 32 may be saline or other non-toxic liquid commonly used to flush eyes. The washing unit 30 is selectively turned on to urge the liquid 32 outwardly through the cup 28 thereby facilitating the eye to be washed. In this way foreign objects that become lodged in the eye may be flushed out of the eye and hazardous chemicals may be washed out of the eye.

The washing unit 30 comprises a reservoir 34 that contains the liquid 32. The reservoir 34 has an outer wall 36 and the outer wall 36 has a fill hole 38 extending into the reservoir 34 for filling the reservoir 34. A plug 40 is removably positioned in the fill hole 38 to close the fill hole 38. The outer wall 36 threadably engages the inner surface of the handle 12 such that the reservoir 34 is removably coupled to first end 14 of the handle 12.

A pump 42 is coupled to the first end 14 of the handle 12 and the pump 42 has an input 44, an output 46 and a return 48. The input 44 is placed in fluid communication with the reservoir 34 when the reservoir 34 is coupled to the handle 12. The output 46 is in fluid communication with the conduit 20 to facilitate the pump 42 to selectively pump 42 the liquid 32 outwardly through the first apertures 22. Moreover, the return 48 is in fluid communication with the interior of the handle 12 and the reservoir 34 to return 48 the fluid from the second apertures 24 to the reservoir 34. In this way the liquid 32 is re-circulated when the pump 42 is turned on. Additionally, a filter 50 is coupled to the return 48 to filter the liquid 32 that is returned to the reservoir 34.

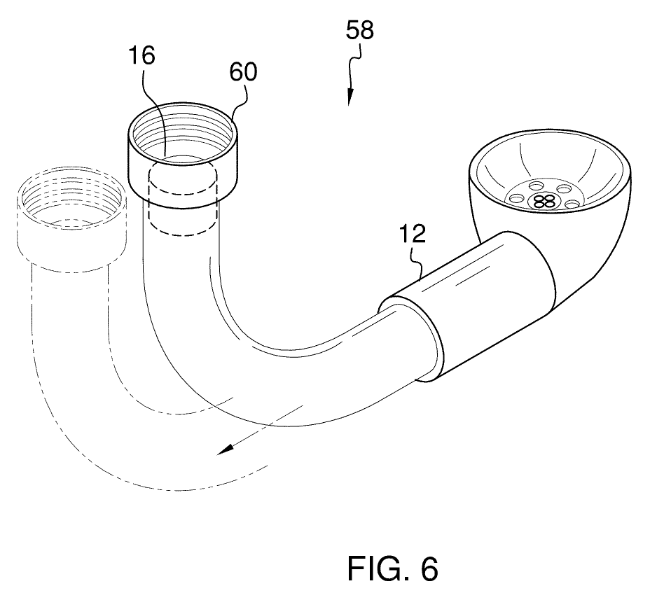

A button 52 is coupled to the handle 12 and the button 52 is manipulated. The button 52 is electrically coupled to the pump 42 and the button 52 turns the pump 42 on and off. A power supply 54 is coupled to the handle 12 and the power supply 54 is electrically coupled to the pump 42. The power supply 54 comprises at least one battery 56. In an alternative embodiment 58 as shown in FIG. 6, a coupler 60 may be coupled to the second end 16 of the handle 12. The coupler 60 may threadably engage a faucet or the like thereby facilitating the faucet to deliver the liquid 32 to the handle 12.

In use, the reservoir 34 is filled with the liquid 32 and the reservoir 34 is attached to the handle 12. The handle 12 is manipulated to align the cup 28 with the eye when a foreign object becomes lodged in the eye, when a chemical is introduced into the eye and for any other reason requiring the eye to be flushed with the liquid 32. The button 52 is manipulated to turn the pump 42 on and the liquid 32 is urged outwardly through each of said first apertures 22 to wash the eye. The cup 28 captures the liquid 32 and directs the liquid 32 through each of the second apertures 24 to re-circulate the liquid 32.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

1. An eye washing assembly being configured to selectively urge a fluid onto eyes for washing the eyes, said assembly comprising:
a handle being configured to be manipulated, said handle having a first end and a second end, said first end being open, said handle being substantially hollow, said handle having a conduit therein, said conduit extending from said second end toward said first end, said handle an inside surface, said inside surface being threaded adjacent to said first end, said second end having a plurality of second apertures extending into an interior of said handle, said second apertures being spaced apart from each other and being distributed around said first apertures;
a cup being coupled to said handle, said cup being coupled to and extending away from said second end, each of said first and second apertures being exposed in said cup inset from a free edge of said cup wherein said cup is configured to be aligned with an eye with said free edge abutting an area around the eye to position said first and second apertures in alignment with the eye; and
a washing unit being coupled to said handle wherein said washing unit is configured to contain a liquid, said washing unit being selectively turned on wherein said washing unit is configured to urge the liquid outwardly through said cup thereby facilitating the eye to be washed.

2. The assembly according to claim 1, further comprising said handle having a bend thereon such that said second end is directed upwardly from said handle, and said handle having an inside surface, said inside surface being threaded adjacent to said first end.

3. (canceled)

4. (canceled)

5. (canceled)

6. The assembly according to claim 2, wherein said washing unit comprises a reservoir being configured to contain the liquid, said reservoir having an outer wall, said outer wall threadably engaging said inner surface of said handle such that said reservoir is removably coupled to first end of said handle.

7. The assembly according to claim 6, further comprising:
a plurality of first apertures extending through said second end of said handle;
a plurality of second apertures extending through said second end of said handle; and
a pump being coupled to said first end of said handle, said pump having an input, an output and a return, said input being placed in fluid communication with said reservoir when said reservoir is coupled to said handle, said output being in fluid communication with said conduit wherein said pump is configured to selectively pump the liquid outwardly through said first apertures, said return being in fluid communication with said interior of said handle and said reservoir wherein said return is configured to return the fluid from said second apertures to said reservoir.

8. The assembly according to claim 7, further comprising a button being coupled to said handle wherein said button is configured to be manipulated, said button being electrically coupled to said pump, said button turning said pump on and off.

9. The assembly according to claim 7, further comprising a power supply being coupled to said handle, said power supply being electrically coupled to said pump, said power supply comprising at least one battery.

10. An eye washing assembly being configured to selectively urge a fluid onto eyes for washing the eyes, said assembly comprising:
a handle being configured to be manipulated, said handle having a first end and a second end, said first end being open, said handle being substantially hollow, said handle having a bend thereon such that said second end is directed upwardly from said handle, said handle having a conduit therein, said conduit extending from said second end toward said first end, said second end having a plurality of first apertures extending into said conduit, said second end having a plurality of second apertures extending into an interior of said handle, said second apertures being spaced apart from each other and being distributed around said first apertures, said handle an inside surface, said inside surface being threaded adjacent to said first end;
a cup being coupled to said handle, said cup being coupled to and extending away from said second end, each of said first and second apertures being exposed in said cup inset from a free edge of said cup wherein said cup is configured to be aligned with an eye with said free edge abutting an area around the eye to position said first and second apertures in alignment with the eye; and
a washing unit being coupled to said handle wherein said washing unit is configured to contain a liquid, said washing unit being selectively turned on wherein said washing unit is configured to urge the liquid outwardly through said cup thereby facilitating the eye to be washed, said washing unit comprising:
a reservoir being configured to contain the liquid, said reservoir having an outer wall, said outer wall threadably engaging said inner surface of said handle such that said reservoir is removably coupled to first end of said handle,
a pump being coupled to said first end of said handle, said pump having an input, an output and a return, said input being placed in fluid communication with said reservoir when said reservoir is coupled to said handle, said output being in fluid communication with said conduit wherein said pump is configured to selectively pump the liquid outwardly through said first apertures, said return being in fluid communication with said interior of said handle and said reservoir wherein said return is configured to return the fluid from said second apertures to said reservoir,
a button being coupled to said handle wherein said button is configured to be manipulated, said button being electrically coupled to said pump, said button turning said pump on and off, and
a power supply being coupled to said handle, said power supply being electrically coupled to said pump, said power supply comprising at least one battery.
